(19) United States
(12) Patent Application Publication
(10) Pub. No.: US 2022/0076485 A1
(43) Pub. Date: Mar. 10, 2022

(54) INFORMATION PROCESSING APPARATUS AND INFORMATION PROCESSING METHOD

(71) Applicant: SONY GROUP CORPORATION, Tokyo (JP)

(72) Inventors: Mitsuru KATSUMATA, Tokyo (JP); Ryohei TAKAHASHI, Kanagawa (JP); Mitsuhiro HIRABAYASHI, Tokyo (JP)

(73) Assignee: SONY GROUP CORPORATION, Tokyo (JP)

(21) Appl. No.: 17/418,598

(22) PCT Filed: Dec. 25, 2019
(86) PCT No.: PCT/JP2019/050760

§ 371 Date: Jun. 25, 2021

(30) Foreign Application Priority Data
Jan. 8, 2019 (JP) 2019-001376

(51) Int. Cl. G06T 17/00; G06T 9/40; H04N 19/597; H04N 19/96

(52) U.S. Cl. CPC G06T 17/005; H04N 19/96; H04N 19/597; G06T 9/40

(57) ABSTRACT

There is provided an information processing apparatus and an information processing method that enable use of a thumbnail for 3D object still image content. A 3D object is used as original data, and role information that is information indicating that thumbnail data generated from the original data is a thumbnail based on the original data is generated. Then, the role information and encoded data obtained by encoding one frame of the 3D object by a predetermined encoding method are stored in a file having a predetermined file structure. The present technology can be applied to, for example, a data generation apparatus that generates a file that stores encoded data of Point Cloud without time information and its thumbnail.

### TECHNICAL FIELD

The present disclosure relates to an information processing apparatus and an information processing method, and particularly to an information processing apparatus and an information processing method that enable use of a thumbnail for a 3D object without time information.

### BACKGROUND ART

Conventionally, as a method of expressing a 3D object, there is Point Clouds, which are represented by a set of points having position information and attribute information (especially color information) at the same time in a three-dimensional space. Then, as disclosed in Non-Patent Documents 1 and 2, methods for compressing a Point Cloud are specified.

For example, as one of methods for compressing a Point Cloud, there is a method in which a Point Cloud is divided into a plurality of areas (hereinafter referred to as segmentation) and each area is projected in a plane to generate a texture image and a geometry image, which are then encoded by a video codec. Here, the geometry image is an image including depth information of point clouds that constitute a Point Cloud. This method is called video-based point cloud coding (V-PCC), and the details thereof are described in Non-Patent Document 1.

Furthermore, as another compression method, there is a method in which a Point Cloud is separated into geometry, which indicates a three-dimensional shape, and attribute, which indicates color and reflection information as attribute information, and they are encoded. This method is called geometry based point cloud coding (G-PCC).

Then, use cases are expected in which V-PCC and G-PCC streams generated by such encoding are downloaded and reproduced or distributed over an Internet protocol (IP) network.

Therefore, as disclosed in Non-Patent Document 3, a study on distribution technologies using ISO base media file format/dynamic adaptive streaming over HTTP (ISOBMFF/DASH), which is an existing framework, in moving picture experts group (MPEG) has started to suppress impacts on existing distribution platforms and realize services at an early stage.

### CITATION LIST

### Non-Patent Document

Non-Patent Document 1: m45183 second working draft for Video-based Point Cloud Coding (V-PCC).
Non-Patent Document 2: m45183 working draft for Geometry-based Point Cloud Coding (G-PCC).
Non-Patent Document 3: w17675, First idea on Systems technologies for Point Cloud Coding, April 2018, San Diego, US

### SUMMARY OF THE INVENTION

### Problems to be Solved by the Invention

By the way, conventionally, like a moving image, a V-PCC stream or G-PCC stream generated by encoding a Point Cloud including a plurality of frames at a predetermined time interval by V-PCC or G-PCC is used in use cases in which it is stored in a file having a file structure using ISOBMFF technology. On the other hand, use cases are also assumed in which, for example, a Point Cloud without time information (that is, a Point Cloud for one frame), such as map data, encoded by V-PCC or G-PCC is stored in a file having a file structure using ISOBMFF technology.

Furthermore, in general, a thumbnail is attached to two-dimensional still image content, and the thumbnail is used as a sample or an index for identifying the original image (in this case, a two-dimensional still image). For example, a list of thumbnails is displayed for the user to select desired two-dimensional still image content from a plurality of pieces of two-dimensional still image content. For this reason, thumbnails are required to reduce the load in decoding processing, display processing, and the like, and in the case of two-dimensional still image content, two-dimensional still image data having a low resolution is used.

Therefore, it is required to enable the use of a thumbnail for a three-dimensional 3D object that does not have time information (hereinafter referred to as 3D object still image content) such as the map data described above.

The present disclosure has been made in view of such a situation, and makes it possible to use a thumbnail for a 3D object without time information.

### Solutions to Problems

The information processing apparatus of an aspect of the present disclosure includes: a preprocessing unit that uses a 3D object as original data and generates role information that is information indicating that thumbnail data generated from the original data is a thumbnail based on the original data; and a file generation unit that stores the role information and encoded data obtained by encoding one frame of the 3D object by a predetermined encoding method, in a file having a predetermined file structure.

The information processing method of an aspect of the present disclosure includes, by an information processing apparatus: using a 3D object as original data and generating role information that is information indicating that thumbnail data generated from the original data is a thumbnail based on the original data; and storing the role information and encoded data obtained by encoding one frame of the 3D object by a predetermined encoding method, in a file having a predetermined file structure.

According to an aspect of the present disclosure, a 3D object is used as original data and role information that is information indicating that thumbnail data generated from the original data is a thumbnail based on the original data is generated; and the role information and encoded data obtained by encoding one frame of the 3D object by a predetermined encoding method are stored in a file having a predetermined file structure.

### BRIEF DESCRIPTION OF DRAWINGS

FIG. 1 is a diagram showing an example of signaling of a thumbnail in HEIF.

FIG. 2 is a diagram explaining octree encoding.

FIG. 3 is a diagram showing an example of extension of ItemReferenceBox that stores role information indicating a picture thumbnail.

FIG. 4 is a diagram showing a variation example of extending ItemReferenceBox that stores role information indicating a picture thumbnail.

FIG. 5 is a diagram showing an example of extension of ItemReferenceBox that stores role information indicating a video thumbnail.

FIG. 6 is a diagram showing a variation example of extension of ItemReferenceBox that stores role information indicating a video thumbnail.

FIG. 7 is a diagram showing an example of a definition of EntityToGroupBox (thmb) for signaling a video thumbnail.

FIG. 8 is a diagram showing an example of signaling that rotates a 3D object thumbnail on a specific axis.

FIG. 9 is a diagram showing coordinate axes.

FIG. 10 is a diagram showing an example of signaling in which a plurality of various rotations is combined.

FIG. 11 is a diagram showing an example of signaling of an initial position.

FIG. 12 is a diagram showing an example of signaling of a viewpoint position, a line-of-sight direction, and an angle of view of a 3D object thumbnail.

FIG. 13 is a diagram showing an example of signaling by ItemProperty.

FIG. 14 is a diagram showing an example of signaling an initial position by ItemProperty.

FIG. 15 is a diagram showing an example of signaling a 3D object thumbnail as a derivative image.

FIG. 16 is a diagram showing a first example of a metadata track of a display rule.

FIG. 17 is a diagram showing a first example of a metadata track of a display rule.

FIG. 18 is a diagram showing a second example of a metadata track of a display rule.

FIG. 19 is a diagram showing an example of associating a display rule with a thumbnail.

FIG. 20 is a diagram showing an example of signaling a 3D object thumbnail by extending GPCCConfigurationBox.

FIG. 21 is a diagram showing an example of a file structure using an extended GPCCConfigurationBox.

FIG. 22 is a diagram showing an example of 3D object thumbnail signaling by GPCCLimitedInfoProperty.

FIG. 23 is a diagram showing an example of a file structure using GPCCLimitedInfoProperty.

FIG. 24 is a diagram showing an example of decoding geometry data to a specific depth by Sequence Parameter Set.

FIG. 25 is a block diagram showing an example of a data generation apparatus.

FIG. 26 is a block diagram showing an example of a data reproduction apparatus.

FIG. 27 is a flowchart explaining file generation processing for generating a file in which a thumbnail is stored.

FIG. 28 is a flowchart explaining file generation processing for generating a file in which a thumbnail is stored.

FIG. 29 is a flowchart explaining thumbnail reproduction processing for reproducing a thumbnail.

FIG. 30 is a block diagram showing a configuration example of an embodiment of a computer to which the present technology has been applied.

### MODE FOR CARRYING OUT THE INVENTION

A specific embodiment to which the present technology has been applied will be described in detail below with reference to the drawings.

<Signaling of Thumbnail in HEIF>

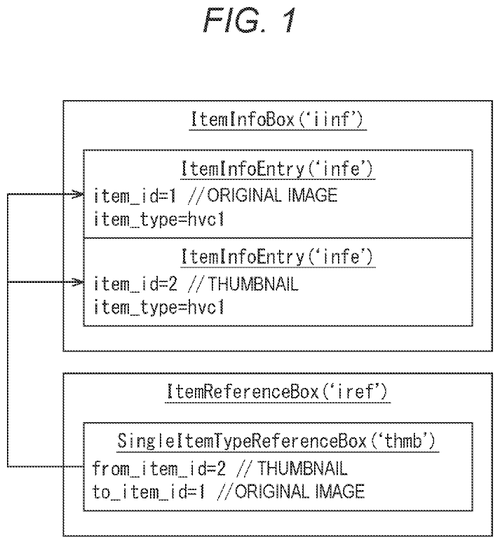

First, signaling of a thumbnail in HEIF will be described with reference to FIG. 1.

For example, a Point Cloud that constitutes 3D object still image content is assumed to be encoded using V-PCC or G-PCC as described above. Encoded data obtained by encoding a Point Cloud that constitutes 3D object still image content using V-PCC is referred to as V-PCC still image data, and encoded data obtained by encoding a Point Cloud that constitutes 3D object still image content using V-PCC is referred to as V-PCC still image data.

Furthermore, ISO/IEC 23008-12 MPEG-H Image File Format (HEIF) can be used as a standard for storing 3D object still image content in a file having a file structure using ISOBMFF technology. On the other hand, a two-dimensional image can be encoded by a moving image codec such as advanced video coding (AVC) or high efficiency video coding (HEVC), and can be stored in a file having a file structure using ISOBMFF as two-dimensional image data without time information.

Therefore, storing V-PCC still image data and G-PCC still image data in a file having a file structure using ISOBMFF technology by regarding the image data as similar to two-dimensional image data that is compressed using a moving image codec and does not have time information can be achieved by, for example, extending HEIF.

Here, in HEIF, thumbnails are defined as “low resolution representation of an original image”. Then, as shown in FIG. 1, role information indicating a thumbnail is stored in ItemReferenceBox (‘iref’). For example, in a Box whose referenceType is ‘thmb’, item_id indicating a thumbnail item is indicated by from_item_id, and item_id of the original image of the thumbnail is indicated by to_item_id. As described above, the role information is information indicating that it is a thumbnail and which original image the thumbnail is based on.

That is, in FIG. 1, the fact that item_id=2 is a thumbnail is indicated by the Box in which referenceType of ItemReferenceBox is ‘thmb’.

Furthermore, in a case where 3D object still image content is stored in a file having a file structure using ISOBMFF technology, 3D object thumbnail data is stored as one item of one stream or divided into a plurality of streams and stored as multi items. For example, in the case of one item, that item is used as the starting point of reproduction. On the other hand, in the case of multi items, the starting point of reproduction is indicated by item or group of EntityToGroupBox.

However, since the existing ItemReferenceBox can only signal a reference relationship between items, in a case where the group is the starting point of reproduction, there is a concern that signaling for the original image cannot be performed. Furthermore, the existing standard assumes that thumbnail data is a two-dimensional still image, and does not assume moving image data or 3D objects with reduced resolution, which are sophisticated thumbnails, and there is a concern that signaling cannot be performed.

Moreover, in a case where a 3D object is used as a thumbnail, the display method (for example, the viewpoint position at which the 3D object is viewed, the line-of-sight direction, the angle of view, the display time, and the like) depends on the client when displaying as a thumbnail. Therefore, the display may be different from the intention of a content author, or the display may be different for each client.

<Use of G-PCC Still Image Data as Original Image and Thumbnail>

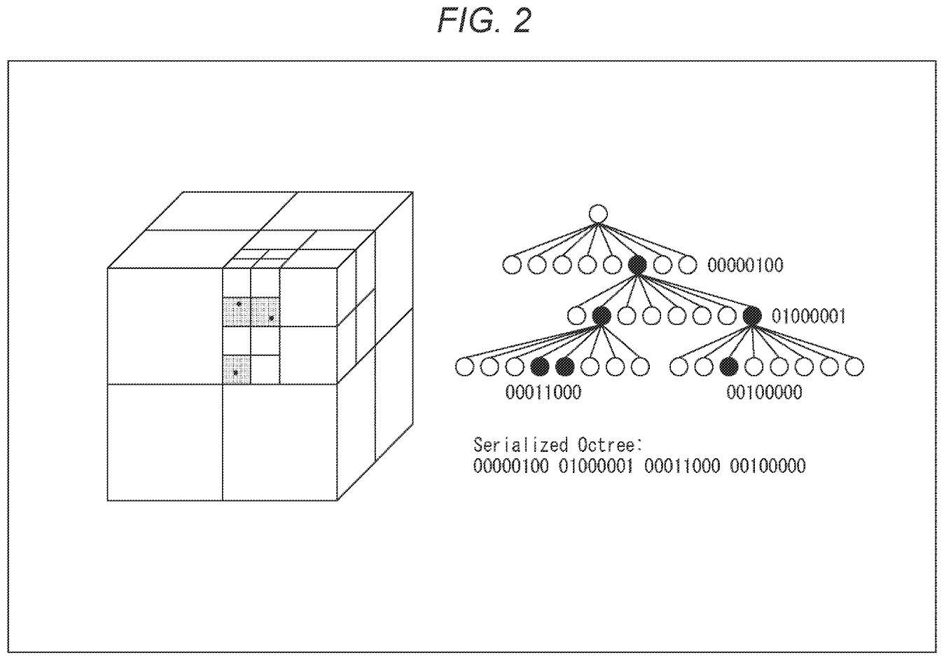

Here, octree encoding as shown in FIG. 2 is used as a method for compressing geometry data of G-PCC still image data.

For example, octree encoding is a method of expressing the presence or absence of Points in each block by octree in Voxel-expressed data in which each Point of Point cloud data is arranged in a space divided into certain blocks. In this method, as shown in FIG. 2, blocks with the point are represented by 1 and blocks without the points are represented by 0. Furthermore, the fineness of this block is called level of detail (LoD), and the larger the LoD, the finer the block.

Then, the Geometry data compressed by octree encoding can be decoded to the depth in the middle of the octree to reconstruct a Point Cloud as a low-resolution Geometry. However, in this case, attribute data such as texture separately needs data of depth of decoding. That is, the Geometry data can be shared between the original image and the thumbnail.

Therefore, in the following, it is proposed to signal low-resolution data including Geometry data common to the original image as a thumbnail.

<Regarding Thumbnail Data Format>

Next, a thumbnail data format of a thumbnail of a Point Cloud that constitutes 3D object still image content will be described.

In the present embodiment, three methods using picture thumbnails, video thumbnails, and 3D object thumbnails are proposed as the thumbnail data format.

A picture thumbnail is two-dimensional still image data in which a 3D object is displayed at a specific viewpoint position, viewpoint direction, and angle of view.

A video thumbnail is moving image data including an image displaying a 3D object at a plurality of viewpoint positions, viewpoint directions, and angles of view.

A 3D object thumbnail is low-resolution encoded Point Cloud data.

For example, in a case where the original image is V-PCC-encoded data, the low-resolution encoded V-PCC data can be used as a 3D object thumbnail. Note that it is not limited to data encoded by the same method for the original image and the 3D object thumbnail. That is, in a case where the original image is V-PCC-encoded data, G-PCC-encoded data, data including Mesh data and texture data, and the like may be used as a 3D object thumbnail.

Similarly, in a case where the original image is G-PCC-encoded data, V-PCC-encoded data, data including Mesh data and texture data and the like can be used for a 3D object thumbnail in addition to the low-resolution encoded G-PCC data.

By the way, when causing the existing thumbnail definition to correspond to a Point Cloud that constitutes 3D object still image content, it is considered that the 3D object thumbnail is applicable among the thumbnail data formats described above. Furthermore, in a case where a 3D object thumbnail is displayed on a 2D display or head mounted display (HMD), an equivalent effect can be obtained by using low-resolution picture thumbnail or video thumbnail rendered as a 2D image as a thumbnail.

Note that in order to indicate the relationship between the thumbnail described above and the 3D object still image content of a Point Cloud, which is the original image, an HEIF thumbnail as shown in FIG. 1 above can be used in a case where the condition described below is met. That is, it is a condition that both things are satisfied: the original image is the 3D object still image content of a Point Cloud and is stored as one item, and the thumbnail is a picture thumbnail or the 3D object thumbnail is stored as one item. Therefore, in the following, first to third methods for enabling signaling of a thumbnail for 3D object still image content even in a case where this condition is not met will be described.

<First Method of Signaling a Thumbnail for 3D Object Still Image Content>

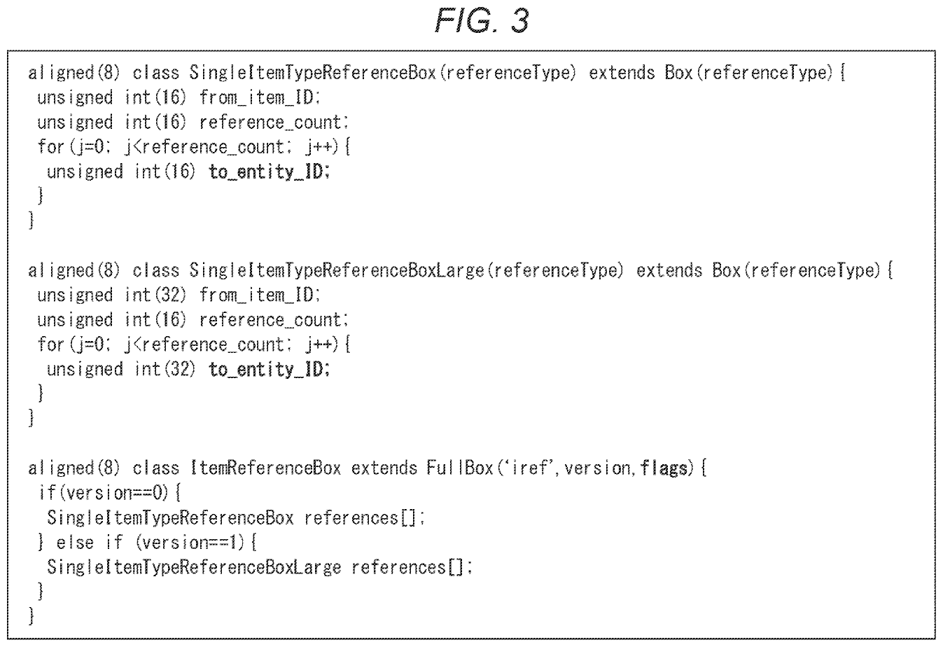

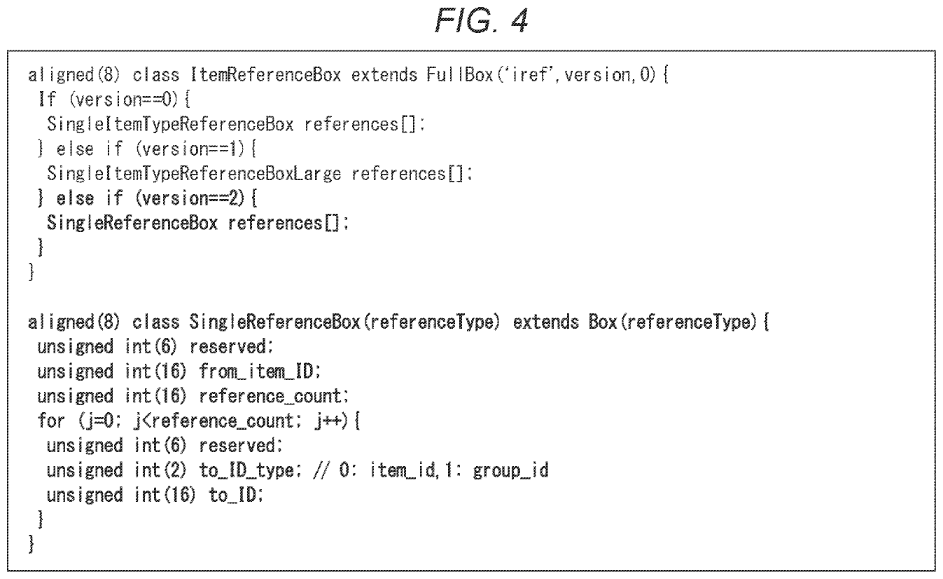

With reference to FIGS. 3 and 4, a method using a picture thumbnail will be described as a first method for signaling a thumbnail for 3D object still image content.

For example, in order to use a picture thumbnail as a thumbnail for 3D object still image content, extension for using a Point Cloud that constitutes the 3D object still image content as the original image is necessary.

Here, there is a case where when the 3D object still image content is stored as multi items in a file having a file structure using ISOBMFF technology, the starting point of reproduction of the original image is indicated by group of EntityToGroupBox. In this case, group_id of EntityToGroupBox is an id that indicates the starting point of reproduction, but since only item can be indicated in ItemReferenceBox, it is assumed that the original image cannot be signaled by ItemReferenceBox. The inability to signal the original image in this way is assumed to be similar not only for picture thumbnails but also for video thumbnails and 3D object thumbnails. Therefore, ItemReferenceBox is extended so that the group can indicate.

FIG. 3 shows an example of extension of ItemReferenceBox that stores role information indicating a picture thumbnail. In FIG. 3, in the parts shown in bold, the 3D object still image content divided and stored as multi items is signaled as the original image.

That is, as shown in FIG. 3, the to_item_ID fields in SingleItemTypeReferenceBox and SingleItemTypeReferenceBoxLarge signaled by ItemReferenceBox are set to to_entity_ID, so that both item_id and group_id can be signaled by this to_entity_ID. Then, in a case where flags&1 of ItemReferenceBox is 1, it indicates that item_id and group_id are signaled by to_entity_ID. On the other hand, in a case where flags&1 of ItemReferenceBox is 0, it indicates that only item_id is signaled by to_entity_ID.

FIG. 4 shows a variation example of extending ItemReferenceBox that stores role information indicating a picture thumbnail. In FIG. 4, in the parts shown in bold, the 3D object still image content divided and stored as multi items is signaled as the original image.

For example, as shown in FIG. 4, version=2 may be added to ItemReferenceBox so that in that case, item_id and group_id can be signaled by signaling indicating the original image. Then, in a case where to_ID_type of SingleReferenceBox is 0, it indicates that item_id is signaled, and in a case where to_ID_type of SingleReferenceBox is 1, it indicates that group_id is signaled.

Note that, the first method can be used for associating groups, tracks, and the like in ItemReferenceBox for purposes other than thumbnails.

<Second Method of Signaling a Thumbnail for 3D Object Still Image Content>

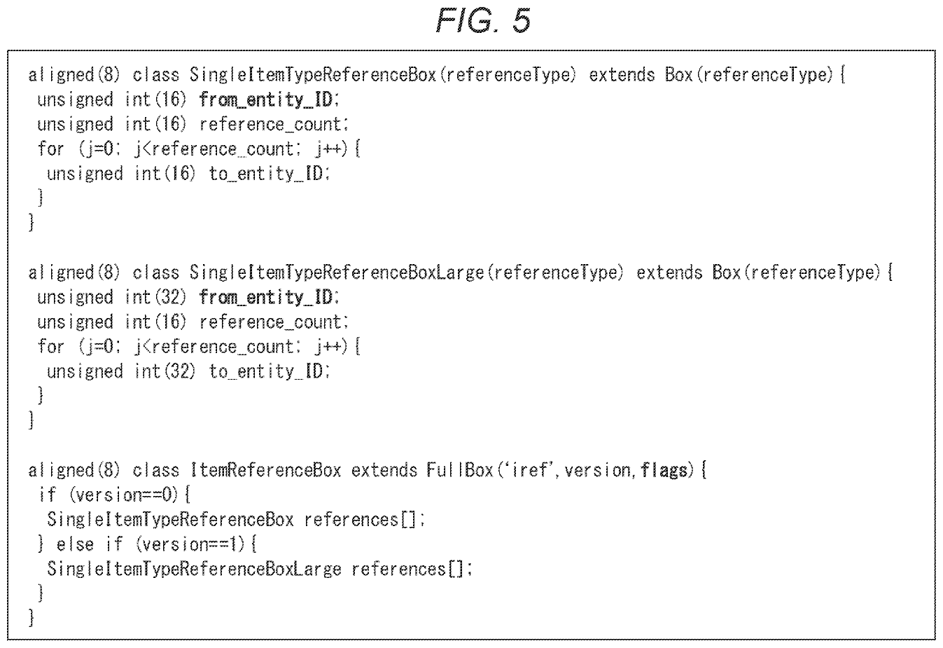

With reference to FIGS. 5 to 7, a method for realizing a video thumbnail will be described as a second method for signaling a thumbnail for 3D object still image content.

First, as a first example of the second method, signaling for associating an original image with a video thumbnail will be described.

The video thumbnail data is Video data encoded by HEVC, AVC, or the like, or an Image sequence in which a plurality of pieces of Image data is provided with time information specified in the HEIF standard. Then, the method for storing Video data or Image sequence in an ISOBMFF track has already been specified in the ISO/IEC standard.

Therefore, as signaling indicating that the video thumbnail data stored in the track is the thumbnail data of the 3D object still image content of a Point Cloud, the first example and the second example of the second method below are described.

In the first example of the second method, the existing ItemReferenceBox is extended to enable signaling of a video thumbnail.

For example, the existing ItemReferenceBox cannot signal a video thumbnail. That is because ItemReferenceBox cannot signal a track that indicates a video thumbnail. Therefore, in order to associate the video thumbnail, it is only necessary to indicate track_id of the track of the video thumbnail. Therefore, ItemReferenceBox is extended so that track_id can be indicated.

FIG. 5 shows an example of extension of ItemReferenceBox that stores role information indicating a video thumbnail. In FIG. 5, video thumbnails are signaled in the parts shown in bold.

That is, the from_item_ID fields of SingleItemTypeReferenceBox and SingleItemTypeReferenceBoxLarge, which are signaled by extending ItemReferenceBox shown in FIG. 3 above, are set to from_entity_ID, and both item_id and track_id can be signaled by this from_entity_ID. Then, in a case where flags&1 of ItemReferenceBox is 1, it indicates that one of item_id, track_id, and group_id is signaled by from_entity_ID or to_entity_ID. On the other hand, in a case where flags&1 of ItemReferenceBox is 0, it indicates that only item_id is signaled. Such extension enables signaling of a video thumbnail by ItemReferenceBox.

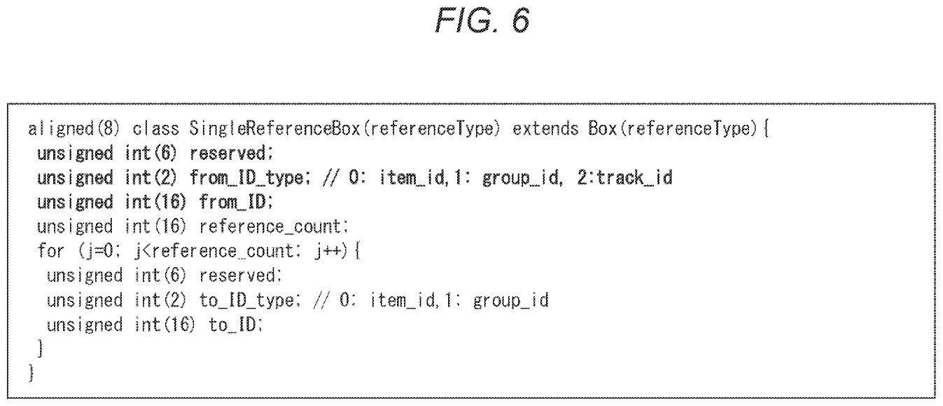

FIG. 6 shows a variation example of extension of ItemReferenceBox that stores role information indicating a video thumbnail. In FIG. 6, video thumbnails are signaled in the parts shown in bold.

For example, the extended SingleReferenceBox as shown in FIG. 4 above may be extended. That is, as shown in FIG. 6, an ID to be signaled is specified by from_ID_type. For example, in a case where from_ID_type is 0, it indicates that item_id is signaled, in a case where from_ID_type is 1, it indicates that group_id is signaled, and in a case where from_ID_type is 2, it indicates that track_id is signaled. Then, in the case of a video thumbnail, from_ID_type is set to 2, and track_id in which the video thumbnail is stored is specified by from_ID.

Note that the fact that group_id can be specified by from_ID_type is assumed to be used in 1 of the first example of the third method as described later.

Note that in the first example of the second method, it is assumed that the existing referenceType ‘thmb’ is used, but in order to explicitly indicate that it is a video thumbnail, ‘vthm’ may be specified in referenceType.

Furthermore, the first example of the second method can be used for associating groups, tracks, and the like in ItemReferenceBox for purposes other than thumbnails.

Next, in the second example of the second method, EntityToGroupBox (‘thmb’) is defined so that the original image and the video thumbnail can be grouped.

That is, the second example of the second method is a method that enables signaling of a video thumbnail by EntityToGroupBox. For example, EntityToGroupBox can signal item_id or track_id in the entity_id field. However, the signaling for grouping the original image and the thumbnail has not been defined, and group_id could not be signaled. Therefore, a group that can indicate a list of the original image and the thumbnail is defined so that group_id can be signaled.

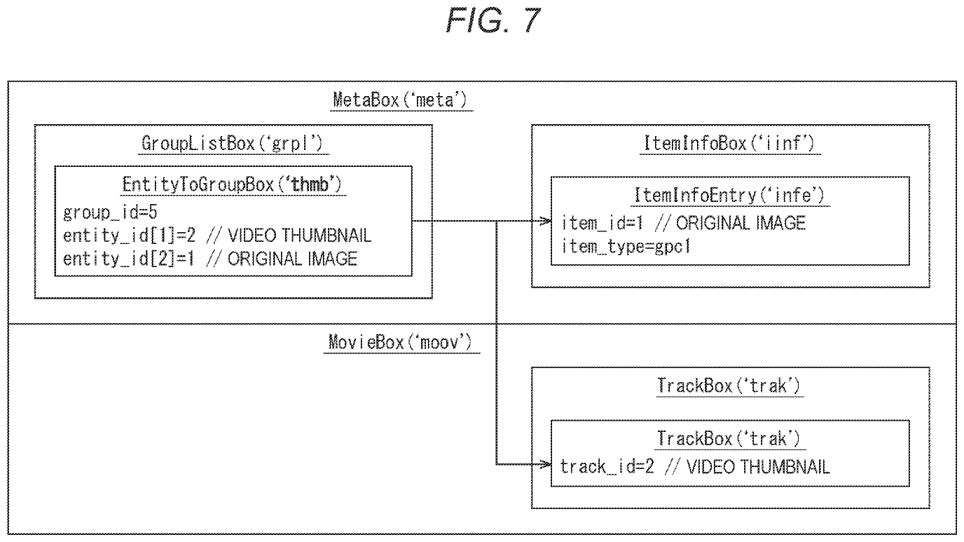

FIG. 7 shows an example of the definition of EntityToGroupBox (thmb) for signaling a video thumbnail.

As shown in FIG. 7, grouping_type of EntityToGroupBox is set to ‘thmb’, indicating that it is grouping indicated by the thumbnail. Then, regarding entity_ids included in EntityToGroupBox, the first one indicates track_id of the video thumbnail, and the second and subsequent ones indicate item_id of the original image.

Moreover, considering the case where the starting point of reproduction of the original image is group_id, group_id can be signaled in the entity_id field. In this case, in a case where flags&1 of EntityToGroupBox is 1, entity_id may explicitly indicate that group_id is signaled in addition to the fact that item_id and track_id are signaled. On the other hand, in a case where flags&1 of EntityToGroupBox is 0, it indicates that one of item_id and track_id is signaled.

Note that, in order to explicitly indicate the video thumbnail, grouping_type dedicated to the video thumbnail may be set to ‘vthm’.

Furthermore, the second example of the second method can be used for associating groups in EntityToGroupBox for purposes other than thumbnails.

<Third Method of Signaling a Thumbnail for 3D Object Still Image Content>

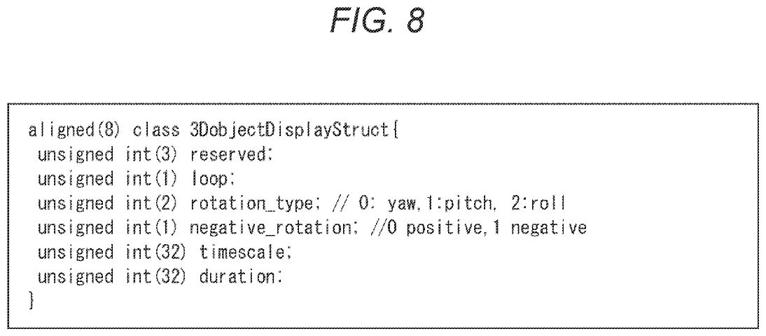

With reference to FIGS. 8 to 24, a method of using a 3D object thumbnail will be described as a third method for signaling a thumbnail for 3D object still image content.

First, in the first example of the third method, a 3D object thumbnail is associated from the original image.

For example, 3D object thumbnail data is Point Cloud data encoded by V-PCC or G-PCC. In a case where it is stored in a file having a file structure using ISOBMFF technology, the 3D object thumbnail data is stored as one item of one stream or divided into a plurality of streams and stored as multi items. As described above, in the case of multi items, the starting point of reproduction is indicated by item or group of EntityToGroupBox.

Therefore, as 1 of the first example of the third method, a method of extending the existing ItemReferenceBox to enable signaling of a 3D object thumbnail will be described.

For example, there is a case where the existing ItemReferenceBox cannot signal a 3D object thumbnail. This is because signaling is not possible in a case where the starting point of reproduction of the 3D object thumbnail is indicated by group_id.

In 1 of the first example of the third method, ItemReferenceBox is extended such that it is extended to be capable of handling the case where the starting point of reproduction of the 3D object thumbnail is indicated by group.

That is, similarly to the ItemReferenceBox (first example of the second method) described above with reference to FIG. 5, a method of storing role information indicating a 3D object thumbnail is used. Then, in 1 of the first example of the third method, it is only required to set from_entity_ID and signal item_id or group_id.

Moreover, as a variation example of 1 of the first example of the third method, as described above with reference to FIG. 6, similarly to the extension of SingleReferenceBox, from_ID_type can be set to 1, and group_id indicating the starting point of reproduction of the 3D object thumbnail can be specified by from_ID.

Note that in 1 of the first example of the third method, ‘3dst’ may be specified in referenceType in order to explicitly indicate that it is a 3D object thumbnail.

In 2 of the first example of the third method, similarly to the second example of the second method described above, EntityToGroupBox (‘thmb’) is defined so that the original image and the 3D object thumbnail can be grouped.

For example, EntityToGroupBox can signal item_id or track_id in the entity_id field. However, the signaling for grouping the original image and the thumbnail has not been defined, and group_id could not be signaled. Therefore, a group that can indicate a list of the original image and the thumbnail is defined so that group_id can be signaled.

As an example of a specific extension, similarly to the second example of the second method described with reference to FIG. 7 above, regarding entity_ids included in EntityToGroupBox, the first one indicates track_id or group_id of the 3D object thumbnail, and the second and subsequent ones indicate item_id or group_id of the original image.

Note that in order to explicitly indicate the 3D object thumbnail, grouping_type dedicated to the 3D object thumbnail may be set to ‘3dst’.

Next, the second example of the third method enables signaling of a display rule of the 3D object thumbnail.

For example, in a case where a 3D object thumbnail is displayed, how to display it depends on the implementation by the client. Specifically, only a certain viewpoint position can be displayed as a 2D image, or a plurality of viewpoint positions can be displayed continuously. For this reason, the intention of the content author who wants to display the 3D object thumbnail properly may not be realized.

Therefore, the second example of the third method enables the content author to signal how to display the 3D object thumbnail. First, the method of signaling a display rule will be described, and further a method of a method for storing the display rule in ISOBMFF will be described.

Note that the second example of the third method is a method for indicating the display rule of the 3D object thumbnail, but it can also be used when automatically displaying the original image. Moreover, it can also be used to indicate which part of the original image is displayed in the picture thumbnail or the video thumbnail.

Signaling of a display rule will be described as 1 of the second example of the third method.

In 1-1 of the second example of the third method, a display rule for rotating the 3D object thumbnail is signaled. That is, 1-1 of the second example of the third method is a method of switching the display of the 3D object thumbnail by fixing the viewpoint position, the line-of-sight direction, and the angle of view and indicating the rotation of the coordinate system of the 3D object thumbnail.

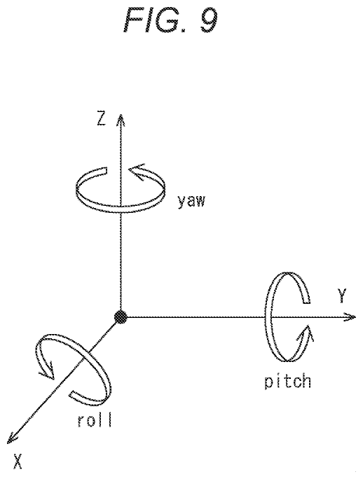

For example, FIG. 8 shows an example of signaling that rotates a 3D object thumbnail on a particular axis. Here, coordinate axes shown in FIG. 9 are used, and the directions of the white arrows with respect to each axis are the directions of forward rotation.

For example, loop indicates whether or not to loop the rotation of the 3D object thumbnail. That is, in a case where loop is 1, it indicates that rotation continues while the 3D object thumbnail is displayed. Furthermore, in a case where loop is 0, it indicates that the 3D object thumbnail rotates only once, and after the 3D object thumbnail rotates once, the initial position is displayed continuously.

Furthermore, rotation_type indicates the coordinate axis around which the 3D object thumbnail rotates. That is, in a case where rotation_type is 0, it indicates rotation around the yaw axis, in a case where rotation_type is 1, it indicates rotation around the pitch axis, and in a case where rotation_type is 2, it indicates rotation around the roll axis.

Furthermore, negative_rotation indicates whether or not the 3D object thumbnail rotates backward. That is, in a case where negative_rotation is 0, it indicates that the 3D object thumbnail does not rotate backward (that is, it rotates forward), and in a case where negative_rotation is 1, it indicates that the 3D object thumbnail rotates backward.

Moreover, timescale and duration indicate the time over which the 3D object thumbnail makes one rotation.

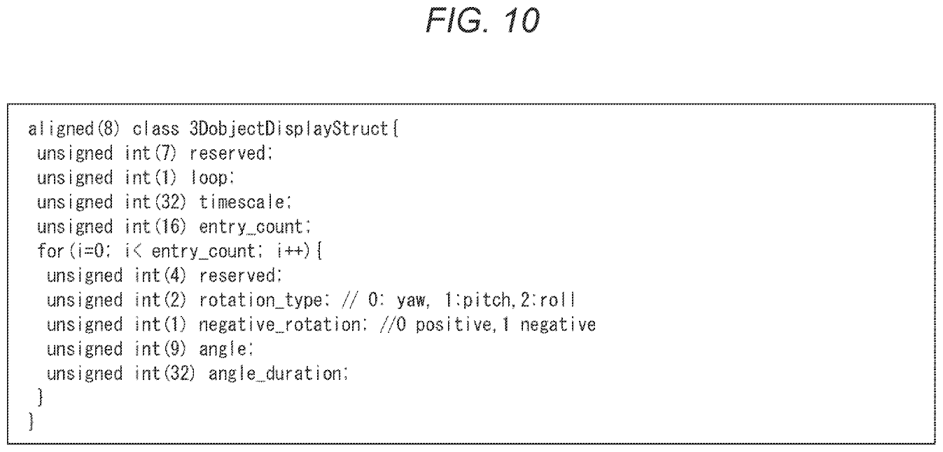

Note that as a variation example of 1-1 of the second example of the third method, a plurality of various rotations in FIG. 8 may be combined. For example, signaling is performed by the structure shown in FIG. 10.

The signaling shown in FIG. 10 differs from the signaling shown in FIG. 8 in that a plurality of rotations is written in succession. Note that in the signaling shown in FIG. 10, the parameters having the same name as in FIG. 8 have similar semantics.

Furthermore, the signaling shown in FIG. 10 is new and enables rotation within one rotation using an angle parameter. That is, angle_duration indicates the time to move the angle indicated by angle.

Here, in 1-1 of the second example of the third method, there is no information regarding the first viewpoint position, line-of-sight direction, and angle of view (hereinafter referred to as the initial position). Therefore, there is a possibility that the initial position changes for each client, and the intention of the content author cannot be realized correctly. Therefore, the initial position may be signaled.

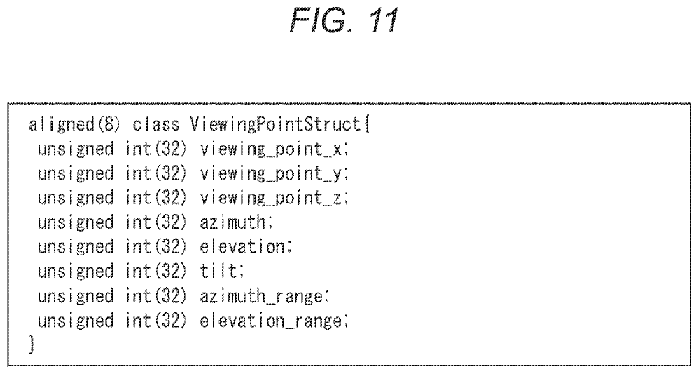

Thus, the initial position may be signaled by ViewingPointStruct as shown in FIG. 11.

In FIG. 11, viewing_point_x, viewing_point_y, and viewing_point_z indicate the viewpoint position of the initial position by coordinates. Furthermore, azimuth, elevation, and tilt indicate the line-of-sight direction of the initial position by angle. Then, the angle of view information to be displayed is indicated by azimuth_range and elevation_range.

Such signaling of the initial position can be used not only when displaying a 3D object thumbnail, but also, for example, when displaying a 3D object of the original image.

In 1-2 of the second example of the third method, the viewpoint position, line-of-sight direction, and angle of view of the 3D object thumbnail are signaled. That is, 1-2 of the second example of the third method is a method of switching the display of the 3D object thumbnail by signaling the viewpoint position, the line-of-sight direction, and the angle of view of the 3D object thumbnail.

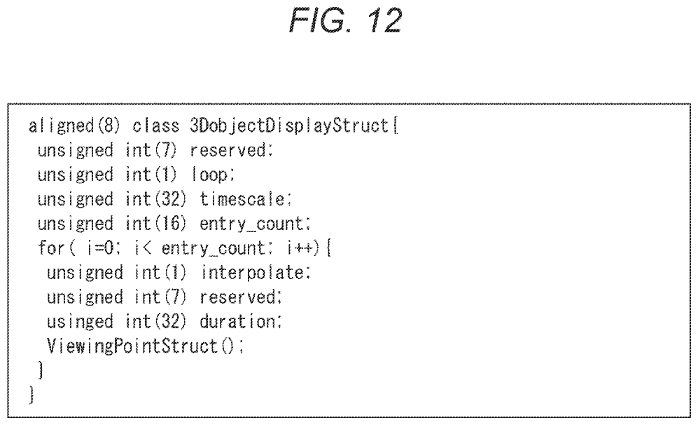

For example, as shown in FIG. 12, ViewingPointStruct defined in FIG. 11 is used to signal a plurality of viewpoint positions, line-of-sight directions, and angles of view of the 3D object thumbnail.

For example, loop indicates whether or not to loop the display of the 3D object thumbnail. That is, in a case where loop is 0, it indicates that it ends when ViewingPointStruct is fully displayed. On the other hand, in a case where loop is 1, it indicates that when ViewingPointStruct is fully displayed, it returns to the beginning and loops to continue displaying.

Furthermore, timescale and duration specify the display time of ViewingPointStruct.

Moreover, interpolate indicates whether or not to complement the display of the 3D object thumbnail. That is, in a case where interpolate is 1, it indicates that the difference from the viewpoint position, the line-of-sight direction, and the angle of view indicated by previous ViewingPointStruct is complemented and displayed within the time of duration. On the other hand, in a case where interpolate is 0, it indicates that such complementary processing is not performed.

Note that as a variation example of 1-2 of the second example of the third method, azimuth, elevation, and tilt are used for the line-of-sight direction, but points (x1, y1, z1) on specific coordinate axes may be specified so that the points are always centered and displayed.

As 2 of the second example of the third method, a method for storing the display rule in ISOBMFF will be described.

In 2-1 of the second example of the third method, the 3D object thumbnail is signaled as ItemProperty. That is, 2-1 of the second example of the third method is a method of signaling by storing the display rule of 1 of the second example of the third method described above in ItemProperty and associating it with Item of the 3D object thumbnail.

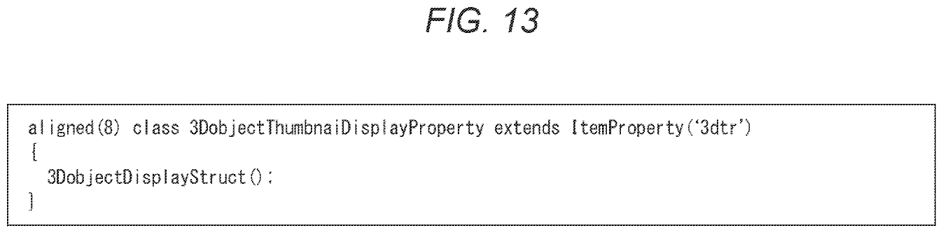

FIG. 13 shows an example of signaling by ItemProperty.

Signaling as shown in FIG. 13 is added as ItemProperty of the 3D object thumbnail, and the client displays according to the display rule in a case where such ItemProperty exists.

Furthermore, similarly, the initial position is also stored in ItemProperty and signaled in association with Item of the 3D object thumbnail.

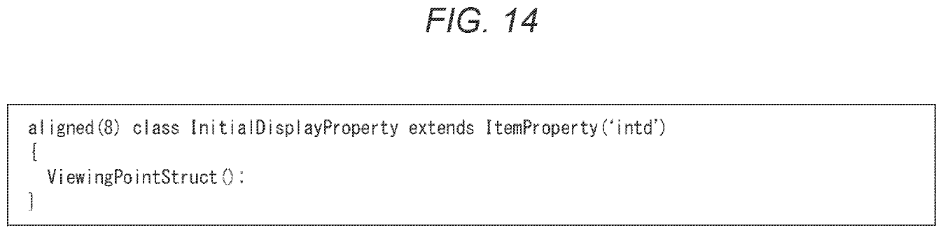

FIG. 14 shows an example of signaling the initial position by ItemProperty.

In 2-2 of the second example of the third method, the 3D object thumbnail is signaled as a derivative image. That is, 2-2 of the second example of the third method is a method of signaling by defining the display rule of 1 of the second example of the third method described above as Item with a new display rule as a derivative image of HEIF.

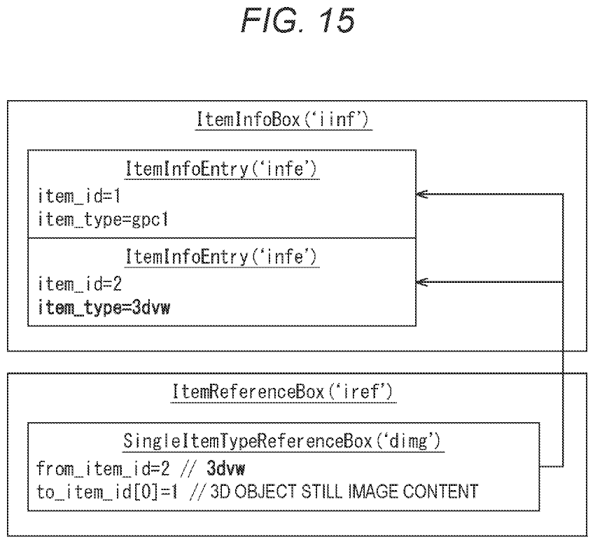

FIG. 15 shows an example of signaling a 3D object thumbnail as a derivative image.

For example, as shown in FIG. 15, ‘3dvw’ is defined as item_type indicating that it is 3D object still image content for which a display rule is specified. 3DobjectDisplayStruct is stored as its Item Data.

Furthermore, in 2-2 of the second example of the third method, the initial position may be stored together in ItemData, or may be signaled by ItemProperty similarly to 1-2 of the second example of the third method.

Note that signaling may be performed together with the 3D object still image content by EntityToGroupBox instead of ItemReference.

In 2-3 of the second example of the third method, the 3D object thumbnail is signaled as a metadata track. That is, 2-3 of the second example of the third method is a method of storing the display rule as a metadata track and associating it with the thumbnail.

First, the method of storing the display rule in the metadata track will be described.

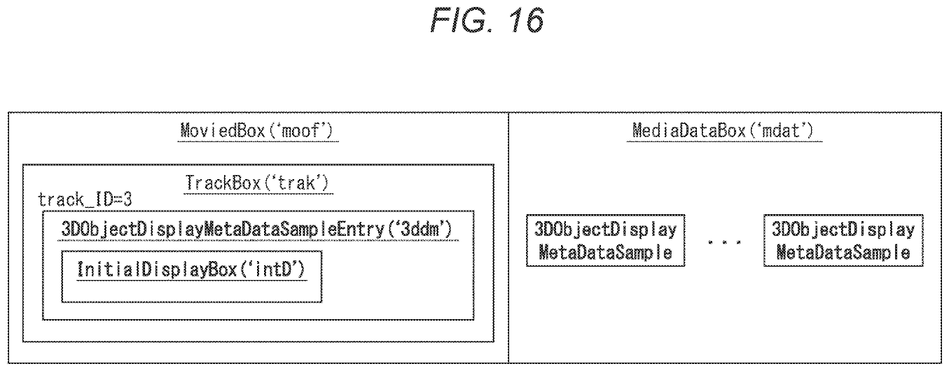

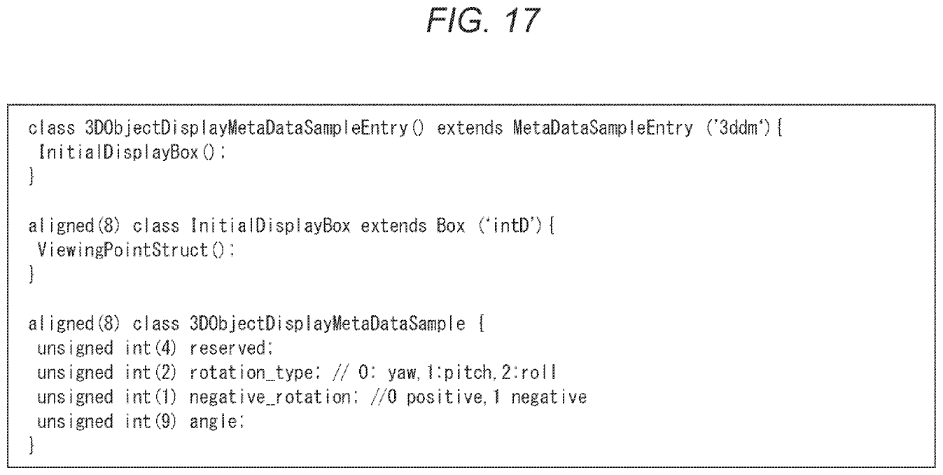

FIGS. 16 and 17 are examples in which FIGS. 10 and 11 shown as the display rule of 1-1 of the second example of the third method described above are represented by a metadata track.

For example, 3DObjectDisplayMetaDataSampleEntry (‘3ddm’) stores information that does not change over time. Furthermore, the initial position and signaling InitialDisplayBox (‘intD’) are stored. Furthermore, the information that changes over time is stored in MediaDataBox (‘mdat’) as a sample. Then, the structure of the sample is indicated in 3DObjectDisplayMetaDataSample.

Furthermore, the information regarding the time not signaled by 3DObjectDisplayMetaDataSample (see FIG. 10 above) maps to the existing ISOBMFF function. Furthermore, as timescale shown in FIG. 10 above, timescale of media header box (‘mdhd’) is used. Similarly, as angle_duration shown in FIG. 10, time to sample box (‘stts’) is used, and as loop shown in FIG. 10, the loop function of edit list box (‘edts’) is used.

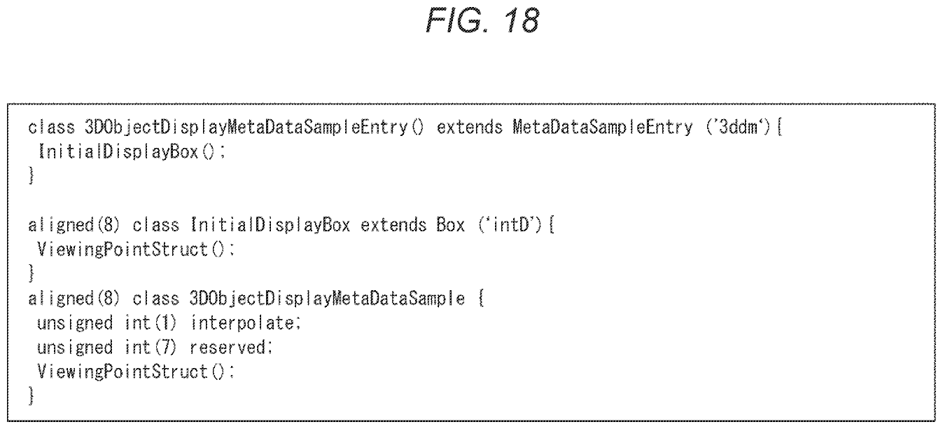

Moreover, in a case where the display rule (see FIG. 12) of 1-2 of the second example of the third method described above is used, it is only required to define 3DObjectDisplayMetaDataSampleEntry (‘3ddm’) and 3DObjectDisplayMetaDataSample as shown in FIG. 18.

For example, the time-related information not signaled by 3DObjectDisplayMetaDataSample (see FIG. 12 above) maps to the existing ISOBMFF function. Furthermore, as timescale shown in FIG. 12, timescale of media header box (‘mdhd’) is used. Similarly, as duration shown in FIG. 12, time to sample box (‘stts’) is used, and as loop shown in FIG. 12, the loop function of edit list box (‘edts’) is used.

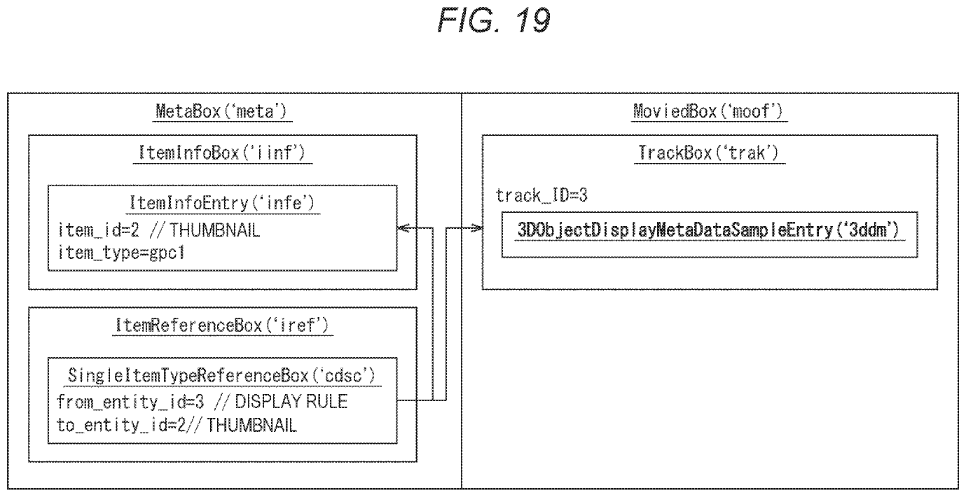

FIG. 19 shows a method of associating the display rule signaled by a metadata track with a thumbnail.

As shown in FIG. 19, ItemReference (‘cdsc’) can associate the track of the display rule with the thumbnail. Here, ItemReference (‘cdsc’) indicates the content description with the already specified referenceType. However, in ItemReference, track_id cannot be signaled, and therefore use of ItemReference extended by the first example of the second method described above enables association.

Note that as a variation example of the second example of the third method, the item and the metadata track of the 3D object thumbnail may be signaled by EntityToGroupBox.

Next, in the third example of the third method, the depth of the Geometry data of the G-PCC still image is limited to obtain a 3D object thumbnail.

For example, when the geometry data of G-PCC still image data is decoded to a specific depth and a Point Cloud is reconstructed, it is possible to configure a Point Cloud with a lower resolution than a Point Cloud whose geometry data is fully decoded, and the processing amount can be reduced. However, the Attribute data (for example, texture) needs to match the information regarding Geometry decoded to a specific depth.

Utilizing this characteristic, information as to how much to decode the Geometry data with the data of the original image is signaled, and the dedicated Attribute data is used as a 3D object thumbnail. However, the Geometry data of the original data cannot be shared in that way. Therefore, metadata for enabling sharing is signaled.

Note that the third example of the third method assumes use as a 3D object thumbnail, but it may be used as a substitute image.

In 1 of the third example of the third method, the depth information of geometry is signaled by GPCCConfigurationBox. That is, 1 of the third example of the third method is a method of indicating that GPCCConfigurationBox of ItemProperty is extended and the geometry data is decoded to a specific depth.

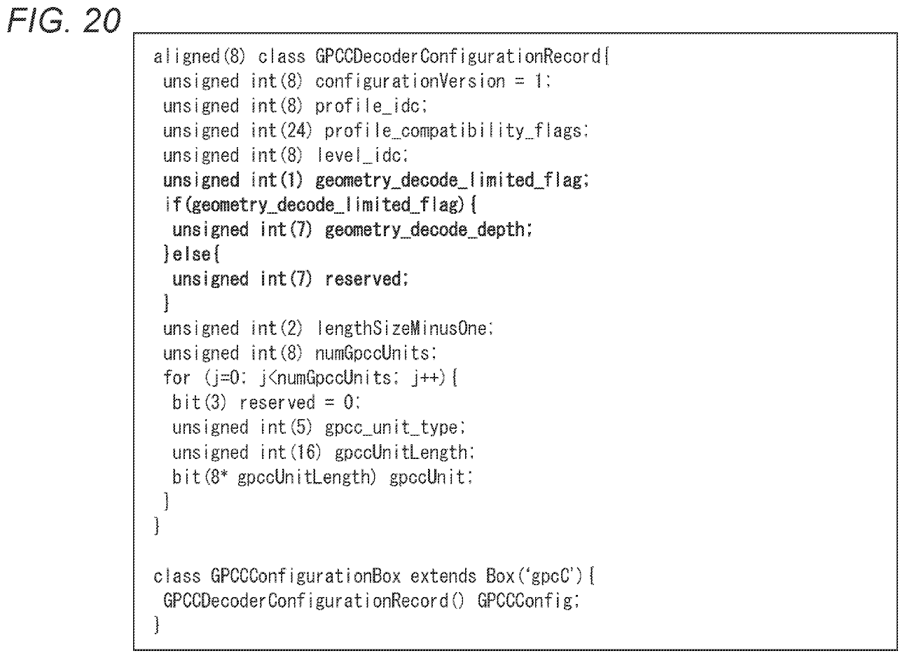

FIG. 20 shows an example of signaling a 3D object thumbnail by extending GPCCConfigurationBox. In FIG. 20, 3D object thumbnails are signaled in the parts shown in bold.

As shown in FIG. 20, geometry_decode_limited_flag indicates whether or not the geometry data is decoded only to a specific depth. For example, in a case where geometry_decode_limited_flag is 1, it indicates that the geometry data is decoded only to a specific depth. On the other hand, in a case where geometry_decode_limited_flag is 0, it indicates that the geometry data is fully decoded. Furthermore, geometry_decode_depth indicates information of decoding depth.

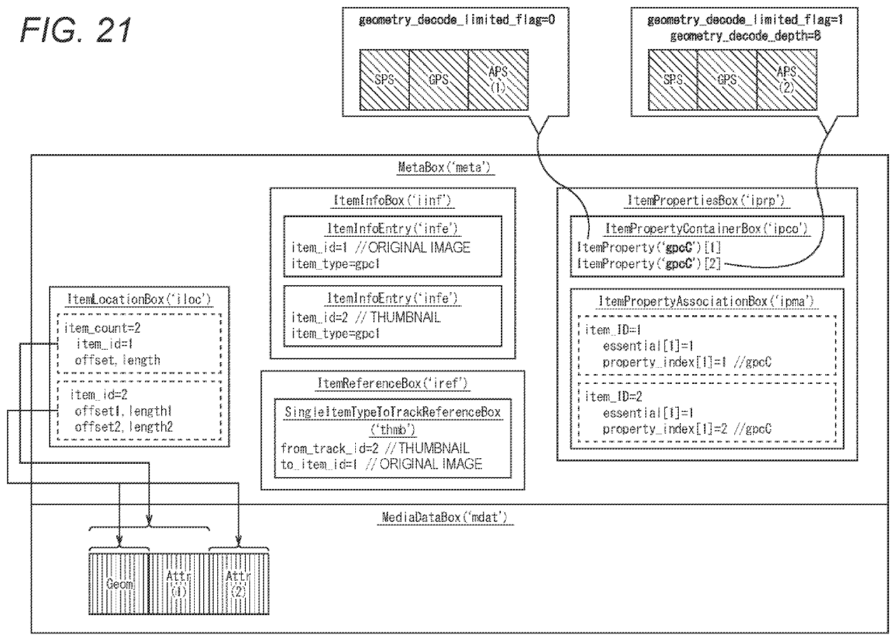

FIG. 21 shows an example of a file configuration in which one original image and one thumbnail exist by using the signaling of 1 of the third example of the third method. In the example shown in FIG. 21, it is assumed that the geometry of the original image has a depth of up to 10. Furthermore, the original image is item_id=1 and the thumbnail is item_id=2.

geometry_decode_limited_flag=0 is signaled in GPCCConfigurationBox (ItemProperty (‘gpcC’)) of ItemProperty of the original image. Therefore, it indicates that the geometry is fully decoded (up to a depth of 10). Furthermore, stored ParameterSet includes SPS, GPS, and APS (1). The data referenced from ItemLocationBox (‘iloc’) indicates offset and length of Geom and Attr (1).

Furthermore, geometry_decode_limited_flag=1 and geometry_decode_depth=8 are signaled in ItemProperty (‘gpcC’) of the thumbnail. Therefore, it indicates that the geometry is decoded to a depth of 8. Furthermore, stored ParameterSet includes SPS, GPS, and APS (2), and the APS is different from that of the original image. Then, the data referenced from ItemLocationBox (‘iloc’) indicates the data of Geom and Attr (2).

Furthermore, the file structure shown in FIG. 21 indicates that item_id=2 is a thumbnail of item_id=1 in ItemReferenceBox (‘iref’).

In 2 of the third example of the third method, new ItemProperty is defined and the depth information of geometry is signaled. That is, 2 of the third example of the third method is a method of defining GPCCLimitedInfoProperty and indicating that the geometry data is decoded to a specific depth.

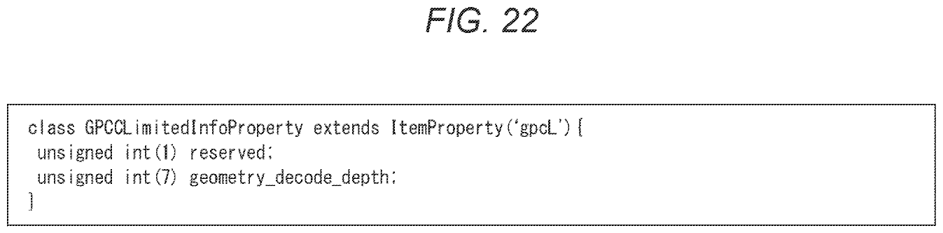

FIG. 22 shows an example of 3D object thumbnail signaling by GPCCLimitedInfoProperty.

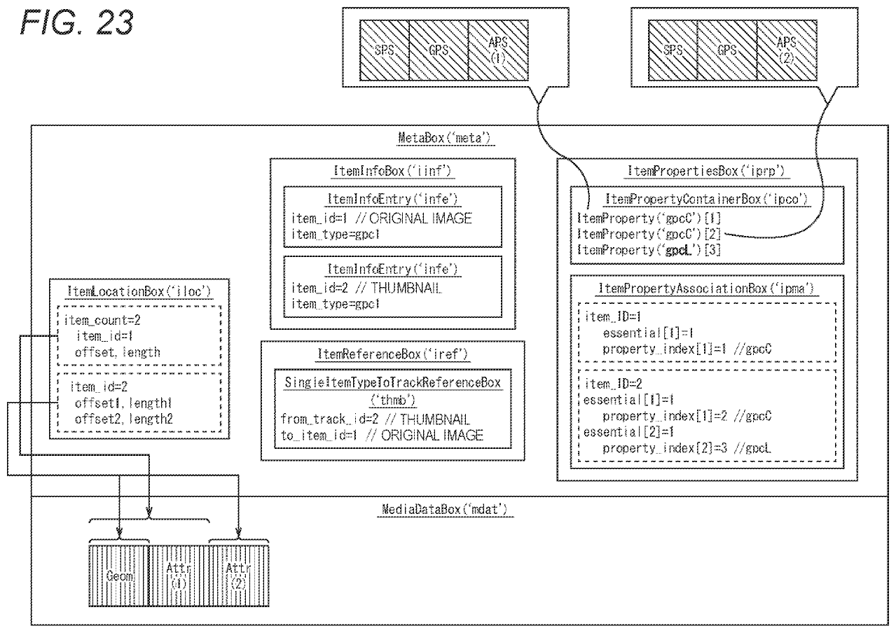

FIG. 23 shows an example of a file configuration in which one original image and one thumbnail exist by using the signaling shown in FIG. 22.

The file configuration shown in FIG. 22 is basically similar to the file configuration shown in FIG. 21, but the depth of geometry data is limited by GPCCLimitedInfoProperty (ItemProperty (‘gpcL’)) of the thumbnail.

In 3 of the third example of the third method, signaling is performed by bitstream of G-PCC. That is, 3 of the third example of the third method is a method of entering a parameter indicating that geometry data is decoded to a specific depth in bitstream of G-PCC.

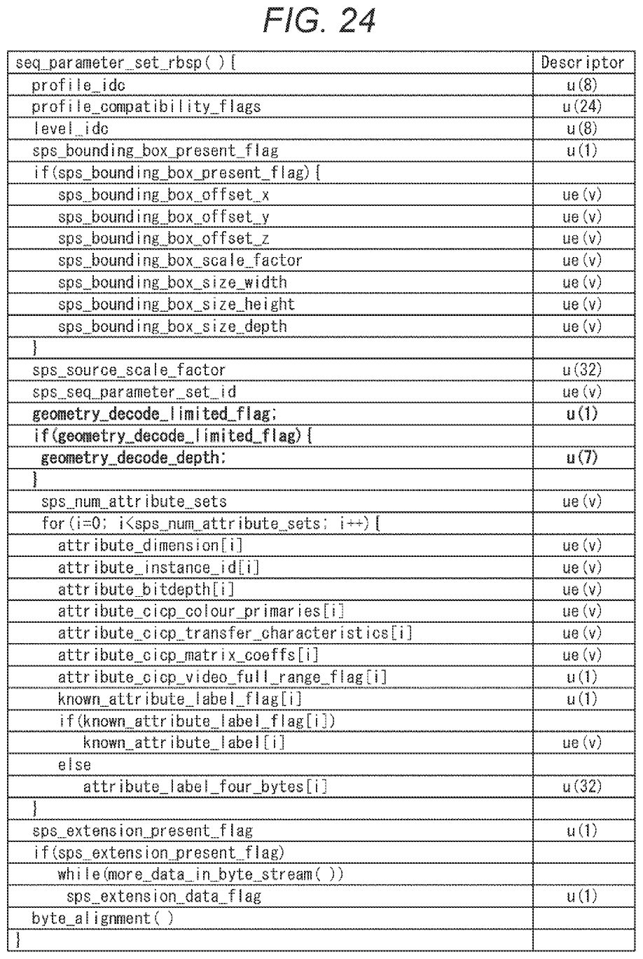

FIG. 24 shows an example indicating that geometry data is decoded to a specific depth by Sequence Parameter Set. Note that the details of the field are similar to those in 1 of the third example of the third method described with reference to FIG. 20.

Note that, in 3 of the third example of the third method, an example of storing in Sequence Parameter Set is given, but signaling may be performed in another place such as Geometry Parameter Set or Geometry bitstream in a manner similar to that in FIG. 24.

<System Configuration>

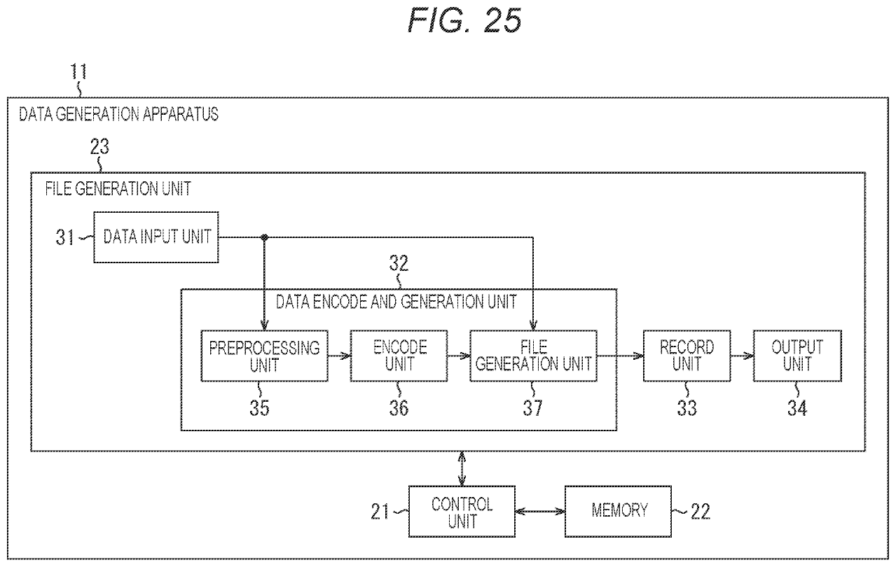

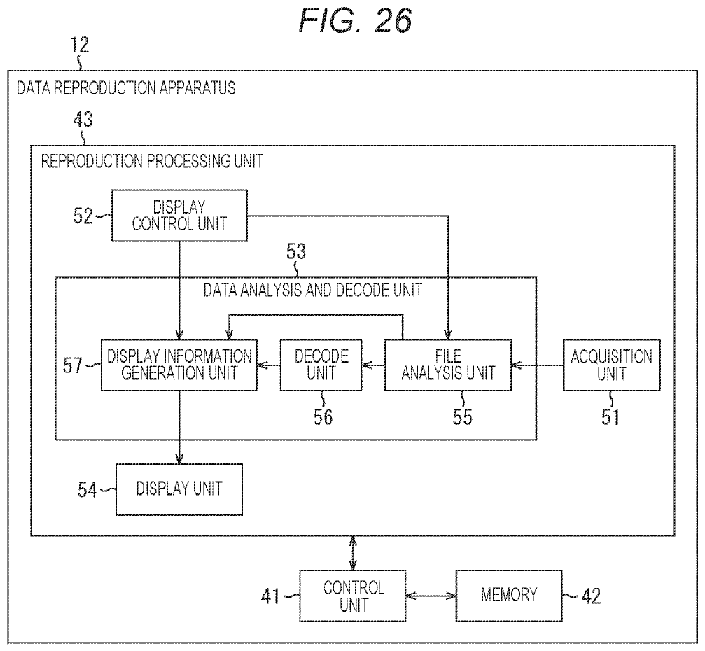

The system configuration of a data generation apparatus and a data reproduction apparatus to which the present technology has been applied will be described with reference to FIGS. 25 and 26.

FIG. 25 shows a block diagram showing a configuration example of the data generation apparatus.

As shown in FIG. 25, a data generation apparatus 11 includes a control unit 21, a memory 22, and a file generation unit 23. For example, the memory 22 stores various data necessary for the control unit 21 to control the file generation unit 23, and the control unit 21 refers to the data and controls the generation of a file in the file generation unit 23.

The file generation unit 23 includes a data input unit 31, a data encode and generation unit 32, a record unit 33, and an output unit 34. For example, the data input to the data input unit 31 is supplied to the data encode and generation unit 32. Then, the file generated by the data encode and generation unit 32 is output from the output unit 34 via the record unit 33, and is recorded on, for example, a recording medium.

The data encode and generation unit 32 includes a preprocessing unit 35, an encode unit 36, and a file generation unit 37.

The preprocessing unit 35 executes processing of generating a geometry image, a texture image, various metadata, and the like from a Point Cloud input from the data input unit 31. Moreover, the preprocessing unit 35 uses the Point Cloud as the original image and generates image data (two-dimensional still image data or moving image data) or low-resolution Point Cloud data to be used as a thumbnail. Then, the preprocessing unit 35 generates role information indicating that the generated image data or low-resolution Point Cloud data is a thumbnail based on the original image and the Point Cloud which is the original image.

The encode unit 36 executes processing of encoding the Point Cloud using V-PCC or G-PCC. Moreover, the encode unit 36 encodes the image data or the low-resolution Point Cloud data used as a thumbnail.

The file generation unit 37 stores the metadata generated by the preprocessing unit 35 together with the V-PCC still image data or the G-PCC still image data in a file having a file structure using ISOBMFF technology, and executes the processing of generating the file. Moreover, the file generation unit 37 stores the data used as the thumbnail encoded by the encode unit 36 and the role information generated by the preprocessing unit 35 in the file.

FIG. 26 shows a block diagram showing a configuration example of the data reproduction apparatus.

As shown in FIG. 26, a data reproduction apparatus 12 includes a control unit 41, a memory 42, and a reproduction processing unit 43. For example, the memory 42 stores various data necessary for the control unit 41 to control the reproduction processing unit 43, and the control unit 41 refers to the data and controls reproduction of the Point Cloud in the reproduction processing unit 43.

The reproduction processing unit 43 includes an acquisition unit 51, a display control unit 52, a data analysis and decode unit 53, and a display unit 54. For example, a file acquired by the acquisition unit 51 and read from, for example, a recording medium is supplied to the data analysis and decode unit 53. Then, a display screen generated by the data analysis and decode unit 53 according to the display control by the display control unit 52 is displayed on the display unit 54.

The data analysis and decode unit 53 includes a file analysis unit 55, a decode unit 56, and a display information generation unit 57.

The file analysis unit 55 extracts V-PCC still image data or G-PCC still image data from a file having a file structure using ISOBMFF technology, and executes processing of analyzing metadata. Moreover, the file analysis unit 55 extracts thumbnail data (for example, image data or low-resolution Point Cloud data used as a thumbnail encoded by the encode unit 36) from the file, and acquires the role information.

Furthermore, the decode unit 56 executes processing of decoding the V-PCC still image data or the G-PCC still image data using V-PCC or G-PCC according to the metadata acquired by the file analysis unit 55. Moreover, the decode unit 56 decodes the image data or the low-resolution Point Cloud data used as a thumbnail.

Furthermore, the display information generation unit 57 constructs the Point Cloud, renders the Point Cloud, and generates a display screen. Moreover, the display information generation unit 57 renders the display screen on which a thumbnail (picture thumbnail, video thumbnail, or 3D object thumbnail) is displayed so as to correspond to the original image according to the role information from the image data or the low-resolution Point Cloud data used as a thumbnail.

<File Generation Processing>

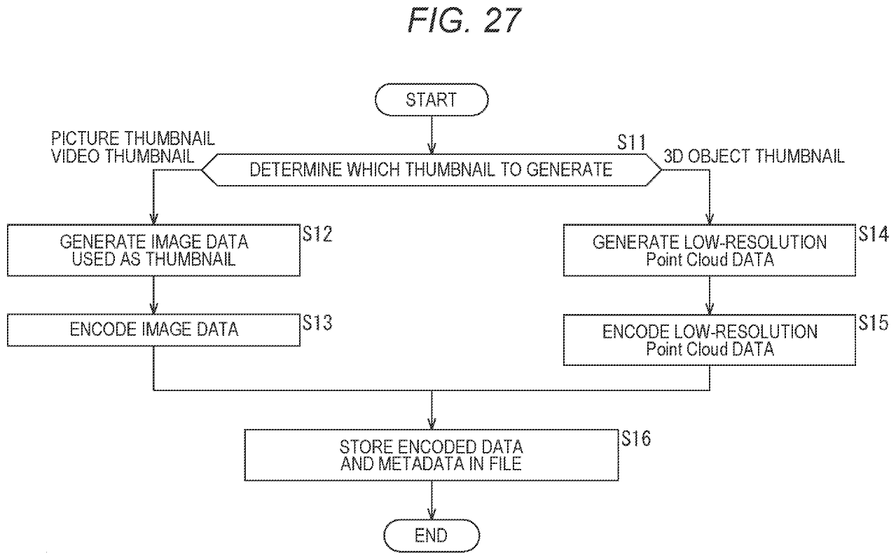

FIG. 27 is a flowchart explaining file generation processing for the data encode and generation unit 32 of the data generation apparatus 11 to generate a file in which a thumbnail is stored. Here, the file generation processing described with reference to FIG. 27 is applied to each method other than 3 of the third example of the third method described above.

In step S11, the data encode and generation unit 32 determines which to generate as a thumbnail data format: a picture thumbnail, a video thumbnail, and a 3D object thumbnail.

In a case where the data encode and generation unit 32 determines in step S11 that a picture thumbnail or a video thumbnail is generated, the processing proceeds to step S12.

In step S12, the preprocessing unit 35 generates image data to be used as a thumbnail and supplies it to the encode unit 36. For example, in a case where a picture thumbnail is generated, the preprocessing unit 35 generates two-dimensional still image data from Point Cloud data according to one viewpoint position, viewpoint direction, and angle of view. Furthermore, in a case where a video thumbnail is generated, the preprocessing unit 35 generates moving image data (i.e., a plurality of pieces of still image data) from Point Cloud data according to a plurality of viewpoint positions, viewpoint directions, and angles of view. Moreover, the preprocessing unit 35 generates role information indicating that the still image data or the moving image data is a thumbnail and the Point Cloud which is the original image from which the thumbnail is generated.

In step 313, the encode unit 36 encodes the image data generated in step 312 and supplies it to the file generation unit 37. That is, the encode unit 36 encodes the two-dimensional still image data or moving image data generated by the preprocessing unit 35 in step 312.

On the other hand, in a case where the data encode and generation unit 32 determines in step S11 that a 3D object thumbnail is generated, the processing proceeds to step S14.

In step S14, the preprocessing unit 35 generates low-resolution Point Cloud data by lowering the resolution of the Point Cloud data and supplies it to the encode unit 36. Moreover, the preprocessing unit 35 generates role information indicating that the low-resolution Point Cloud data is a thumbnail and the Point Cloud which is the original image from which the thumbnail is generated.

In step S15, the encode unit 36 encodes the low-resolution Point Cloud data generated by the preprocessing unit 35 in step S14 using, for example, V-PCC or G-PCC, and supplies it to the file generation unit 37.

In step S16, the file generation unit 37 stores the data encoded by the encode unit 36 in step S13 or S15 in a file using ISOBMFF technology so as to include the role information which is the metadata, and the processing ends.

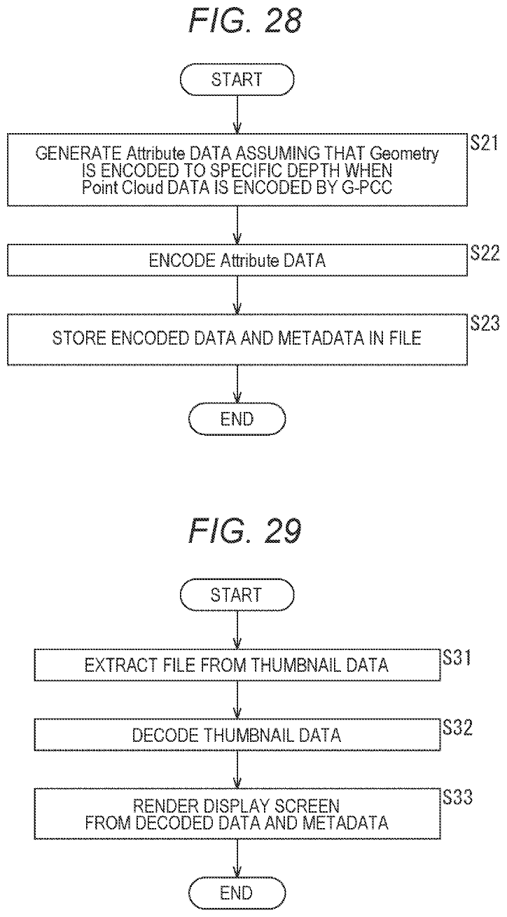

FIG. 28 is a flowchart explaining file generation processing for the data encode and generation unit 32 of the data generation apparatus 11 to generate a file in which a thumbnail is stored. Here, the file generation processing described with reference to FIG. 28 is applied to 3 of the third example of the third method described above.

In step S21, the preprocessing unit 35 generates Attribute data assuming that Geometry when encoding Point Cloud data using G-PCC is encoded to a specific depth, and supplies the Attribute data to the encode unit 36. Moreover, the preprocessing unit 35 generates role information indicating that the generated Attribute data corresponds to the thumbnail and the Point Cloud which is the original image to be encoded to the depth according to the Attribute data.

In step S22, the encode unit 36 encodes the Attribute data generated by the preprocessing unit 35 in step S21 and supplies it to the file generation unit 37.

In step S23, the file generation unit 37 stores the data (Attribute data) encoded by the encode unit 36 in step S23 in a file using ISOBMFF technology so as to include the role information which is the metadata, and the processing ends.

Note that although the description of the processing of storing the original image in the file is omitted in the flowcharts of FIGS. 27 and 28, the data obtained by encoding normal-resolution Point Cloud data (that is, the original image) in the encode unit 36 using V-PCC or G-PCC is stored in the file using ISOBMFF technology by the file generation unit 37.

FIG. 29 is a flowchart explaining thumbnail reproduction processing for the data analysis and decode unit 53 of the data reproduction apparatus 12 to reproduce a thumbnail.

In step S31, the file analysis unit 55 extracts thumbnail data (for example, the data encoded in step S13 or S15 of FIG. 27) from the file supplied from the acquisition unit 51 and supplies it to the decode unit 56. Furthermore, the file analysis unit 55 also extracts the stored role information together with the thumbnail data and supplies it to the display information generation unit 57.

In step S32, the decode unit 56 decodes the thumbnail data supplied from the file analysis unit 55 in step S31, and supplies the data acquired by the decoding to the display information generation unit 57.

In step S33, the display information generation unit 57 renders the display screen on which a thumbnail (picture thumbnail, video thumbnail, or 3D object thumbnail) is displayed so as to correspond to the original image according to the data decoded by the decode unit 56 in step S32 and the role information which is the metadata supplied from the file analysis unit 55 in step S31.

Then, after the processing of step S33, the display screen rendered by the display information generation unit 57 is displayed on the display unit 54 of FIG. 26.

As described above, in a case where 3D object still image content is used as the original image, the present technology can access any of two-dimensional still image data, moving image data, and low-resolution encoded Point Cloud data as the thumbnail data. In this way, by using the moving image data or the low-resolution encoded Point Cloud data as a thumbnail, the content author can provide the user with a more sophisticated thumbnail. Therefore, the user can obtain a large amount of content of the content from the thumbnail. Furthermore, the encoding format of the thumbnail data can be freely set regardless of the encoding format of the original image.

Furthermore, in a case where 3D object still image content is used as thumbnail data, the intention of the content author can be conveyed to the client, and the client can perform displaying according to the intention of the content author. By displaying in this way, it is possible to perform displaying uniformly among a plurality of clients.

For example, the display rule and initial position information can be used not only for thumbnails but also for original images. In this way, when using the original image, the content can be viewed from various positions without the user having to operate it. Furthermore, depending on the client, it is possible to display thumbnails with a reduced amount of processing by displaying only the initial position at the time of display and displaying according to the display rule when the focus is applied.

Furthermore, the user can change the thumbnail display only by editing the metadata without changing the thumbnail data itself.

Moreover, in a case where G-PCC is used as the original image and the thumbnail, the same bitstream data can be shared for 3D object still image content and thumbnail data by limiting the decoding depth of the geometry bitstream. Therefore, the amount of data can be reduced by the amount that it is not necessary to include the geometry bitstream for thumbnail data. This method can be used not only for thumbnails but also for low-resolution substitute images.

<Computer Configuration Example>

Next, the series of processing (information processing method) described above can be performed by hardware, and it can also be performed by software. In a case where the series of processing is performed by software, a program constituting the software is installed in a general-purpose computer or the like.

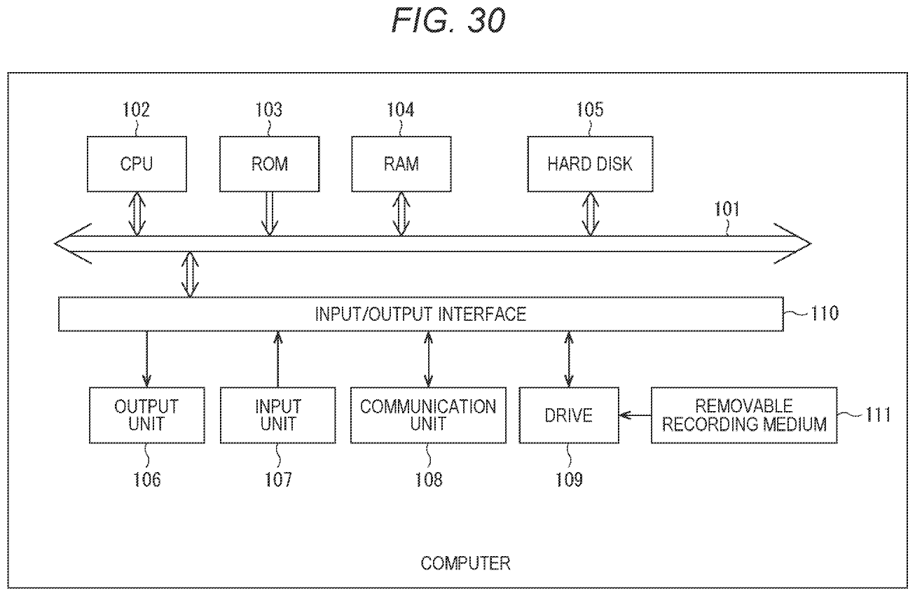

FIG. 30 is a block diagram showing a configuration example of an embodiment of a computer in which a program that executes the series of processing described above is installed.

The program may be preliminarily recorded on a hard disk 105 or a ROM 103, which is a recording medium incorporated in a computer.

Alternatively, the program can be stored (recorded) in a removable recording medium 111 driven by a drive 109. Such a removable recording medium 111 can be provided as so-called package software. Here, examples of the removable recording medium 111 include a flexible disc, a compact disc read only memory (CD-ROM), a magneto optical (MO) disc, a digital versatile disc (DVD), a magnetic disc, a semiconductor memory, or the like.

Note that the program may not only be installed in a computer from the removable recording medium 111 described above, but also be downloaded into a computer and installed in the incorporated hard disk 105 via a communication network or a broadcast network. In other words, for example, the program can be wirelessly transferred to a computer from a download site via an artificial satellite for digital satellite broadcast, or can be transferred to a computer by wire via a network, e.g., a local area network (LAN) or the Internet.

The computer incorporates a central processing unit (CPU) 102. An input/output interface 110 is connected to the CPU 102 via a bus 101.

When a command is input by an operation or the like of the input unit 107 by the user via the input/output interface 110, the CPU 102 executes the program stored in a read only memory (ROM) 103 accordingly. Alternatively, the CPU 102 loads the program stored in the hard disk 105 into a random access memory (RAM) 104 and executes the program.

Thus, the CPU 102 performs the processing following the aforementioned flowchart or the processing performed by the configuration of the aforementioned block diagram. Then, the CPU 102 causes the processing result to be, output from an output unit 106, transmitted from a communication unit 108, recorded by the hard disk 105, or the like, for example, via the input/output interface 110, as needed.

Note that the input unit 107 includes a keyboard, a mouse, a microphone, or the like. Furthermore, the output unit 106 includes a liquid crystal display (LCD), a speaker, or the like.

Here, in the present specification, the processing performed by the computer according to the program is not necessarily needed to be performed in chronological order along the procedure described as the flowchart. In other words, the processing performed by the computer according to the program also includes processing that is executed in parallel or individually (e.g., parallel processing or processing by an object).

Furthermore, the program may be processed by a single computer (processor) or may be processed in a distributed manner by a plurality of computers. Moreover, the program may be transferred to and executed by a remote computer.

Moreover, in the present specification, a system means a cluster of a plurality of constituent elements (apparatuses, modules (parts), etc.) and it does not matter whether or not all the constituent elements are in the same casing. Therefore, a plurality of apparatuses that is housed in different enclosures and connected via a network, and a single apparatus in which a plurality of modules is housed in a single enclosure are both the system.

Furthermore, for example, the configuration described as one apparatus (or processing unit) may be divided and configured as a plurality of apparatuses (or processing units). On the contrary, the configurations described above as a plurality of apparatuses (or processing units) may be collectively configured as one apparatus (or processing unit). Furthermore, of course, a configuration other than the above may be added to the configuration of each apparatus (or each processing unit). Moreover, when the configuration and operation of the entire system are substantially the same, a part of the configuration of an apparatus (or processing unit) may be included in the configuration of another apparatus (or another processing unit).

Furthermore, for example, the present technology can adopt a configuration of cloud computing in which one function is shared and jointly processed by a plurality of apparatuses via a network.

Furthermore, for example, the above-mentioned program can be executed in any apparatus. In that case, it is sufficient if the apparatus has necessary functions (functional blocks, and the like) so that necessary information can be obtained.

Furthermore, for example, each step described in the above-described flowcharts can be executed by a single apparatus or shared and executed by a plurality of apparatuses. Moreover, in a case where a single step includes a plurality of pieces of processing, the plurality of pieces of processing included in the single step can be executed by a single apparatus or can be shared and executed by a plurality of apparatuses. In other words, a plurality of pieces of processing included in one step can be executed as processing of a plurality of steps. On the contrary, the processing described as a plurality of steps can be collectively executed as one step.

Note that for the program executed by the computer, the processing of a step writing the program may be executed in chronological order along the order described in the present description or may be executed individually at a required timing, e.g., when call is carried out. That is, as long as there is no contradiction, the processing of each step may be executed in an order different from the above-mentioned order. Moreover, the processing of the step for writing this program may be executed in parallel with the processing of another program, or may be executed in combination with the processing of another program.

Note that a plurality of the present technologies described in the present specification can be independently implemented alone as long as there is no contradiction. Of course, any plurality of the present technologies can be carried out in combination. For example, some or all of the present technologies described in any of the embodiments may be carried out in combination with some or all of the present technologies described in another embodiment. Furthermore, it is also possible to carry out some or all of any of the above-mentioned present technologies in combination with another technology not described above.

<Example of Configuration Combination>

Note that the present technology may be configured as below.

(1)

An information processing apparatus including:

a preprocessing unit that uses a 3D object as original data and generates role information that is information indicating that thumbnail data generated from the original data is a thumbnail based on the original data; and

a file generation unit that stores the role information and encoded data obtained by encoding one frame of the 3D object by a predetermined encoding method, in a file having a predetermined file structure.

(2)

The information processing apparatus according to (1), in which

the role information includes information that serves as a starting point of reproduction of the encoded data.

(3)

The information processing apparatus according to (2), in which

the information that serves as the starting point of reproduction also includes group identification information that identifies a stream of the encoded data to be reproduced.

(4)

The information processing apparatus according to any of (1) to (3), in which

the preprocessing unit generates the role information indicating two-dimensional still image data as the thumbnail, wherein the two-dimensional still image data is obtained by displaying the 3D object according to a specific viewpoint position, viewpoint direction, and angle of view.

(5)

The information processing apparatus according to any of (1) to (3), in which

the preprocessing unit generates the role information indicating as the thumbnail a video thumbnail that is moving image data including an image which is obtained by displaying the 3D object according to a plurality of viewpoint positions, viewpoint directions, and angles of view.

(6)

The information processing apparatus according to (5), in which

the file generation unit stores the role information indicating the video thumbnail in ItemReferenceBox.

(7)

The information processing apparatus according to (5), in which

the file generation unit stores the role information indicating the video thumbnail in EntityToGroupBox.

(8)

The information processing apparatus according to any of (1) to (3), in which

the preprocessing unit generates the role information indicating as the thumbnail a 3D object thumbnail that is the 3D object encoded at low resolution.

(9)

The information processing apparatus according to (8), in which

the file generation unit stores the role information indicating the 3D object thumbnail in ItemReferenceBox.

(10)

The information processing apparatus according to (8), in which

the file generation unit stores the role information indicating the 3D object thumbnail in EntityToGroupBox.

(11)

The information processing apparatus according to (8), in which

the preprocessing unit generates a display rule for the 3D object thumbnail.

(12)

The information processing apparatus according to (11), in which

the display rule for the 3D object thumbnail includes metadata indicated by rotation during display of the 3D object thumbnail.

(13)

The information processing apparatus according to (11), in which

the display rule for the 3D object thumbnail includes metadata indicated by a viewpoint position, a line-of-sight direction, and an angle of view during display of the 3D object thumbnail.

(14)

The information processing apparatus according to (11), in which

the file generation unit stores an initial position of display of the 3D object thumbnail in the file.

(15)

The information processing apparatus according to any of (11) to (14), in which

the file generation unit stores the display rule for the 3D object thumbnail in ItemProperty.

(16)

The information processing apparatus according to any of (11) to (14), in which

the file generation unit stores the display rule for the 3D object thumbnail in Item.

(17)

The information processing apparatus according to any of (11) to (14), in which

the file generation unit stores the display rule for the 3D object thumbnail in meta track.

(18)

The information processing apparatus according to (8), in which

in a case where geometry based point cloud coding (G-PCC) is used for the 3D object thumbnail, the preprocessing unit generates the role information for using data with limited Geometry decoding as the thumbnail.

(19)

The information processing apparatus according to (18), in which

the preprocessing unit generates the role information indicating that Geometry decoding is limited by ItemProperty.

(20)

An information processing method including, by an information processing apparatus:

using a 3D object as original data and generating role information that is information indicating that thumbnail data generated from the original data is a thumbnail based on the original data; and

storing the role information and encoded data obtained by encoding one frame of the 3D object by a predetermined encoding method, in a file having a predetermined file structure.

Note that the present embodiment is not limited to the aforementioned embodiments, and various changes may be made within a scope without departing from the gist of the present disclosure. Furthermore, the effects described in the present specification are merely illustrative and are not limitative, and other effects may be provided.

### REFERENCE SIGNS LIST

11 Data generation apparatus
12 Data reproduction apparatus
21 Control unit
22 Memory
23 File generation unit
31 Data input unit
32 Data encode and generation unit
33 Record unit
34 Output unit
Preprocessing unit
36 Encode unit
37 File generation unit
41 Control unit
42 Memory
43 Reproduction processing unit
51 Acquisition unit
52 Display control unit
53 Data analysis and decode unit
54 Display unit
55 File analysis unit
56 Decode unit
57 Display information generation unit

1. An information processing apparatus comprising:
a preprocessing unit that uses a 3D object as original data and generates role information that is information indicating that thumbnail data generated from the original data is a thumbnail based on the original data; and
a file generation unit that stores the role information and encoded data obtained by encoding one frame of the 3D object by a predetermined encoding method, in a file having a predetermined file structure.

2. The information processing apparatus according to claim 1, wherein
the role information includes information that serves as a starting point of reproduction of the encoded data.

3. The information processing apparatus according to claim 2, wherein
the information that serves as the starting point of reproduction also includes group identification information that identifies a stream of the encoded data to be reproduced.

4. The information processing apparatus according to claim 3, wherein
the preprocessing unit generates the role information indicating two-dimensional still image data as the thumbnail, wherein the two-dimensional still image data is obtained by displaying the 3D object according to a specific viewpoint position, viewpoint direction, and angle of view.

5. The information processing apparatus according to claim 3, wherein
the preprocessing unit generates the role information indicating as the thumbnail a video thumbnail that is moving image data including an image which is obtained by displaying the 3D object according to a plurality of viewpoint positions, viewpoint directions, and angles of view.

6. The information processing apparatus according to claim 5, wherein
the file generation unit stores the role information indicating the video thumbnail in ItemReferenceBox.

7. The information processing apparatus according to claim 5, wherein
the file generation unit stores the role information indicating the video thumbnail in EntityToGroupBox.

8. The information processing apparatus according to claim 2, wherein
the preprocessing unit generates the role information indicating as the thumbnail a 3D object thumbnail that is the 3D object encoded at low resolution.

9. The information processing apparatus according to claim 8, wherein
the file generation unit stores the role information indicating the 3D object thumbnail in ItemReferenceBox.

10. The information processing apparatus according to claim 8, wherein
the file generation unit stores the role information indicating the 3D object thumbnail in EntityToGroupBox.

11. The information processing apparatus according to claim 8, wherein
the preprocessing unit generates a display rule for the 3D object thumbnail.

12. The information processing apparatus according to claim 11, wherein
the display rule for the 3D object thumbnail is indicated by rotation during display of the 3D object thumbnail.

13. The information processing apparatus according to claim 11, wherein
the display rule for the 3D object thumbnail is indicated by a viewpoint position, a line-of-sight direction, and an angle of view during display of the 3D object thumbnail.

14. The information processing apparatus according to claim 11, wherein
the file generation unit stores an initial position of display of the 3D object thumbnail in the file.

15. The information processing apparatus according to claim 11, wherein
the file generation unit stores the display rule for the 3D object thumbnail in ItemProperty.

16. The information processing apparatus according to claim 11, wherein
the file generation unit stores the display rule for the 3D object thumbnail in Item.

17. The information processing apparatus according to claim 11, wherein
the file generation unit stores the display rule for the 3D object thumbnail in meta track.

18. The information processing apparatus according to claim 8, wherein
in a case where geometry based point cloud coding (G-PCC) is used for the 3D object thumbnail, the preprocessing unit generates the role information for using data with limited Geometry decoding as the thumbnail.

19. The information processing apparatus according to claim 18, wherein
the preprocessing unit generates the role information indicating that Geometry decoding is limited by ItemProperty.

20. An information processing method comprising, by an information processing apparatus:
using a 3D object as original data and generating role information that is information indicating that thumbnail data generated from the original data is a thumbnail based on the original data; and
storing the role information and encoded data obtained by encoding one frame of the 3D object by a predetermined encoding method, in a file having a predetermined file structure.
